(19) United States
(12) Patent Application Publication
(10) Pub. No.: US 2019/0019200 A1
(43) Pub. Date: Jan. 17, 2019

(54) SYSTEMS AND METHODS FOR ANALYZING ELECTRONIC MESSAGES FOR CUSTOMER DATA

(71) Applicant: OpenFan, Inc., Los Angeles, CA (US)

(72) Inventors: Nathan Matthew Lew, Los Angeles, CA (US); Christopher Bryce Danzig, New York, NY (US); Jesse Henry Chan-Norris, New York, NY (US)

(21) Appl. No.: 15/649,501

(22) Filed: Jul. 13, 2017

(51) Int. Cl. G06Q 30/02

(52) U.S. Cl. CPC G06Q 30/0201; H04L 51/32

(57) ABSTRACT

Various embodiments described herein provide for analyzing electronic messages for data of a participant, who may be an existing or potential customer with respect to a client. In particular, some embodiments are implemented as a customer analytics system to analyze electronic messages from participants and extract participant interest data therefrom, which can include historical transactional data relating to a set of organizations. The interest data can be utilized to determine a set of attributes for participants, which in turn can assist a client to the participant analytics system (e.g., client associated with an organization) with collecting, visualizing, or taking action based on determined participant attributes (e.g., calculating and generating a graphical dashboard for participant metrics).

### TECHNICAL FIELD

The present disclosure relates generally to customer analytics and, more particularly, various embodiments described herein provide for systems, methods, techniques, instruction sequences, and devices for analyzing electronic messages for customer data.

### BACKGROUND

With the emergence of the Internet, electronic messaging, social media networks, and online retailers, online interactions have become a normal part of a modern individual's everyday life. These everyday online interactions (e.g., visiting websites and electronic communications) usually result in immense amounts of data being continuously generated, some of which relate to the modern individuals and which, through analytics, can provide meaningful insights into those individuals' preferences or behaviors (e.g., interests, spending preferences, or purchasing habits). Additionally, an analytics tool can use collected data to calculate, among other things, metrics, performances, and statistics regarding individuals (e.g., existing or potential customers, such as a fan of an artist or a celebrity) associated with the data. Leveraging the insights and calculations, can guide organizations, such as retailers or service providers, in their decisions, actions, and strategies (e.g., with respect to reaching out to existing or potential customers).

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a flowchart illustrating an example method for customer analytics, according to some embodiments.

FIG. 2 is a block diagram illustrating an example high-level client-server-based network architecture including a customer analytics system that implements an embodiment.

FIG. 3 is a diagram illustrating an example system for customer analytics, according to some embodiments.

FIGS. 4 and 5 are flowcharts illustrating example methods for customer analytics, according to some embodiments.

FIG. 6 is a set of screenshots illustrating example interfaces for an online campaign that facilitates participant access authorization, according to some embodiments.

FIG. 7 is a screenshot illustrating an example graphical dashboard for customer analytics, according to some embodiments.

FIG. 8 is a block diagram illustrating a representative software architecture, which may be used in conjunction with various hardware architectures herein described, according to various embodiments of the present disclosure.

FIG. 9 is a block diagram illustrating components of a machine able to read instructions from a machine storage medium and perform any one or more of the methodologies discussed herein according to various embodiments of the present disclosure.

### DETAILED DESCRIPTION

Various embodiments described herein provide for analyzing electronic messages for customer data. In particular, some embodiments are implemented as a customer analytics system to analyze electronic messages from participants, who can represent existing or potential customers, and extract participant interest data therefrom, which can include historical transactional data (e.g., stock keeping unit (SKU)-level data, product description, and service descriptions) relating to a set of organizations. Example organizations can include, without limitation, retailers, such as Amazon®, eBay®, and StubHub® and service providers, such as Spotify® and Apple Music®. Example organizations can also include, without limitation, individuals or groups of individuals, such as artists or celebrities. The interest data can be utilized to determine a set of attributes for participants, which in turn can assist a client to the customer analytics system (e.g., client associated with an organization) with collecting, visualizing, or taking action based on determined participant attributes (e.g., calculating and generating a graphical dashboard for participant metrics). For instance, a client may use certain embodiments to facilitate sending targeted electronic messaging (e.g., e-mails or social media messages) to participants (e.g., existing or potential customers) based on prior spending history gleaned from data extracted from participant electronic messages. This may facilitate target advertising by a client. In another instance, a client may use certain embodiments to provide participants with access to purchase certain items (e.g., concert tickets, merchandise) or services (e.g., streaming video or music services). By way of various embodiments, a client (e.g., that is representing, or that is part of, an organization) can access consumer intelligence and targeting data for participants, who are either existing or potential customers, and can do so without direct access to retailer data, which often is not readily available to all interested parties (e.g., a client).

The description that follows includes systems, methods, techniques, instruction sequences, and devices that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As used herein, a participant can include any individual whose electronic messages (e.g., e-mails) can be ingested and processed by an embodiment described herein. With respect to a client, a participant may be an existing customer or a potential customer. As used herein, an electronic message provider can include a service that hosts electronic message for a participant. Example electronic message provider may include a public or private e-mail services, which can include electronic message services internal to social media networks (e.g., provided by Facebook® or LinkedIn®). As used herein, an organization can include any organization (e.g., retailer or service provider) capable of sending an electronic message to participants. An organization may comprise an entity (real or fictitious), an individual, or a group of individuals. An organization may or may not offer a product or service for sale. Example organizations can include, without limitation: retailers, service providers; artists; and celebrities.

Reference will now be made in detail to embodiments of the present disclosure, examples of which are illustrated in the appended drawings. The present disclosure may, however, be embodied in many different forms and should not be construed as being limited to the embodiments set forth herein.

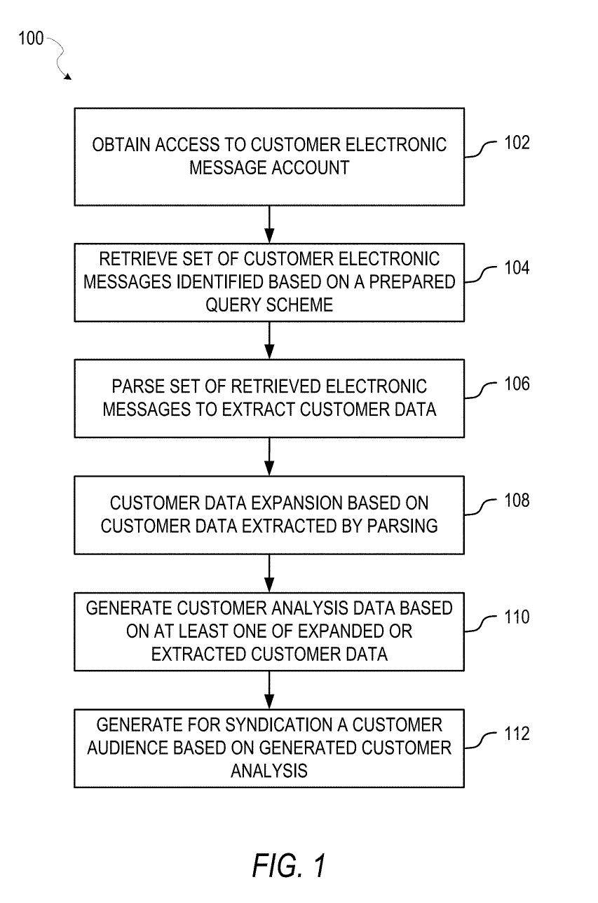

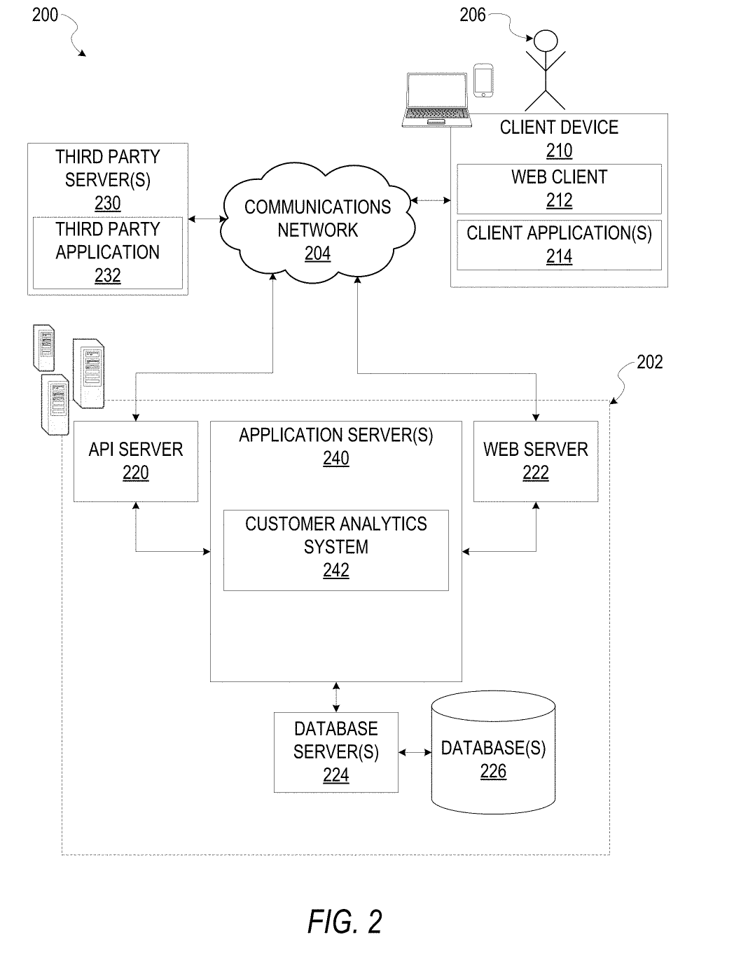

FIG. 1 is a flowchart illustrating an example method 100 for customer analytics, according to some embodiments. For some embodiments, the method 100 is performed, at least in part, by a system, such as a customer analytics system 242 described below with respect to FIG. 2. An operation of the method 100 (or another method described herein) may be performed by a hardware processor (e.g., central processing unit or graphics processing unit) of a computing device (e.g., desktop, server, etc.).

The method 100 begins with operation 102 obtaining access to an electronic message account associated with a participant (participant electronic message account). The method 100 continues with operation 104 which, through the access obtained by operation 102, retrieves, from the participant electronic message account, a set of participant electronic messages identified within the participant electronic message account based on a prepared query scheme. The method 100 continues with operation 106 parsing the set of electronic messages retrieved from the participant electronic message account in operation 104, to extract participant data from the set of electronic messages. The method 100 continues with operation 108 expanding on participant data based on data extracted by parsing performed at operation 106. The method 100 continues with operation 110 generating participant analysis data based on at least one of the expanded participant data of operation 108 or extracted participant data of operation 106. The method 100 continues with operation 112, which, based on participant analysis data generated by operation 110, generates a participant audience for syndication. More regarding operations 102 through 112 is described below.

With respect to operation 102, various embodiments obtain access to a participant's electronic message account by obtaining authorization to access the electronic message account from the participant. In particular, participants may register with an embodiment and, in the process, may authorize access to their electronic messages stored on the electronic message account. The registration process can result in creation of a participant profile that is maintained by an embodiment, and which can be associated with one or more if the participant's electronic message accounts (e.g., each identified by a different electronic message address).

An electronic messages account may reside on a server associated with an electronic message service (e.g., operated by a third-party). The access authorization process may involve obtaining access credentials from the participant directly or, alternatively, obtaining them from the electronic messaging service (e.g., via OAuth) upon permission from the participant. Alternatively, the electronic messages may be retrieved and stored on the participant's local computing device (e.g., in an e-mail client application), in which case an embodiment may request access to those locally stored electronic messages stored (e.g., request access to the e-mail client application). It will be understood that operation 102 may be performed with respect to a plurality of the participant's electronic message accounts (e.g., each electronic message account for which the participant wishes to authorize access).

There may be a variety of approaches by which participants may register with an embodiment. One such approach may involve online campaigns accessible to participants by their networked client devices, such as through a web browser operating on a mobile phone. According to some embodiments, the online campaign may be generated (e.g., established or setup) by a client representing an organization, such as a retail entity. The online campaign may include a benefit (e.g., discount, special offers, or special access to a product or service) or incentive (e.g., prize, such as backstage passes) that the participant receives in return for registering with the online campaign.

The online campaign may include one or more interfaces that facilitate the registration including, without limitation, a registration widget (e.g., that embeds into a third-party's website), a micro web site (e.g., website created specifically for the online campaign), and a sign-in interface for a service provided by entity (e.g., organization or individual) that implements an embodiment. Once the online campaign is launched (e.g., accessible to the public), a participant can use one of the online campaign's interfaces to register to the online campaign and, while doing so, may authorize (e.g., using OAuth, an open standard access delegation service) an embodiment with access to the participant's electronic messaging account provided by a third-party service provider. The authorization may be by way of the electronic messaging service provider (e.g., Google Gmail® or Yahoo® mail) or a third-party identity provider (e.g., Google® or Facebook® Connect). A participant may, for instance, register with an online campaign by entering with their Google® or with their Facebook® account.

For some embodiments, a participant authorizes access to two or more electronic messaging accounts at the time of registration. Alternatively, a participant may authorize a single electronic messaging account for each registration with the online campaign, permitting a participant to register multiple times to the same online campaign (e.g., to submit multiple entries to win the online campaign incentive). For instance, a participant may choose to enter an online campaign (involving a sweepstake prize) twice by authorizing access to electronic messages from both their Google® and Facebook® accounts, thereby giving them twice the odds of winning.

With respect to operation 104, various embodiments use access, obtained by operation 102, to identify and retrieve a set of electronic messages from the participant's electronic message account. The set of electronic messages may be accessed via an application program interface (API) of an electronic message service provider. According to some embodiments, once access is obtained, an electronic message is retrieved and parsed. It will be understood that operation 104 may be performed with respect to a plurality of the participant's electronic message accounts (e.g., each electronic message account for which the participant authorizes access).

Depending on the embodiment, an electronic message retrieval process may involve a set of query schemes, each of which may be used to identify, within one or more participant electronic message accounts, electronic messages of a particular type (hereafter, electronic message type) to be retrieved from the one or more participant electronic message accounts. Accordingly, with respect to electronic messages available for access from a participant's electronic message account, a query scheme may facilitate searching for or filtering through electronic messages to identify those of interest with respect to the particular electronic message type. A query scheme may comprise, for example, a predetermined query string, which may be submitted through an electronic message account search interface (e.g., API). The result of the search may comprise a set of electronic messages matching the predetermined query string, thereby providing the retrieved set of electronic messages identified based on a query scheme. Alternatively, the result of the search may comprise a listing of electronic messages (e.g., listing of electronic message identifiers) matching the predetermined query string. With a listing of electronic messages, various embodiments can retrieve a set of the messages identified by the listing of electronic messages. For some embodiments, the set of messages retrieved by operation 104 may be placed within a queue for further processing.

A query scheme may be associated with a particular type of electronic message (e.g., e-mails received from a specific mailing list) or with a plurality of electronic message types (e.g., generally associated with e-mail receipts indicating payment through PayPal®). Additionally, different versions of a given query scheme (e.g., the same search query in different query languages) may exist to accommodate different types of interfaces offered by electronic message accounts for searching or filtering electronic messages (e.g., the API for searching e-mails on Google® Gmail® may differ from the API used to do the same with respect to Yahoo® mail).

As used herein, an electronic message type may be generally associated with multiple electronic message senders (e.g., a given electronic message type applicable to all retailers), or may be uniquely associated to a single, specific electronic message sender (e.g., a given electronic message type applicable to just Amazon®). Further, a specific electronic message sender (e.g., eBay®) may have a plurality of associated electronic message types (e.g., each to accommodate a different type of e-mail receipt eBay® sends to its customers).

For some embodiments, a query scheme for a particular electronic message type is generated based on a set of sample electronic messages. An example process for generating a query scheme may comprise first collecting sample electronic messages for a target organization (e.g., a retailer or a charitable organization). For a particular electronic message type, a set of sample electronic messages may be collected from each type of electronic message service to account for differences that may exist between different electronic message services.

Once collected, the example process for generating a query scheme may examine each sample electronic message for one or more of the following example characteristics of an electronic message: sender electronic message address; subject line; body content-type (e.g., text-only, or Hypertext Markup Language (HTML)); body content (e.g., salutation or a hyperlink); and organization information (e.g., retailer contact information or physical address). From the examined characteristics, the example process may compile a set of unique combinations of characteristics. For instance, where the characteristics examined by the example process are sender electronic message addresses and subject lines, the example process may compile a set of unique combinations of sender electronic message addresses and subject lines.

Subsequently, the example process generates a set of custom queries where each custom query relates to a unique combination from the set of unique combinations compiled by the example process. For some embodiments, the set of custom queries generated by the example process constitutes the set of query schemes. Where an embodiment determines that a subject line of a unique combination is too specific (e.g., specific to a particular participant or a particular purchase order), the embodiment may extract a subsection of the subject line to generate a custom query that is unique enough to distinguish a target electronic message type from a non-target electronic message type.

Each custom query may comprise a query language compatible with a particular electronic message service provider. Accordingly, the set of participant queries may comprise a subset of custom queries for each unique combination from the set of unique combinations, where each custom query in the subset of custom queries comprises query language compatible with a particular electronic message service provider. Through the set of custom queries, various embodiments can retrieve at least some (if not all) of the electronic messages to be retrieved and processed.

With respect to operation 106, various embodiments use a set of parsing schemes (e.g., parsing algorithms or engines) to parse some or all of the raw data contained by an electronic message (e.g., each electronic message) retrieved by operation 104. Operation 106 may receive retrieved electronic messages from operation 104 by way of a queue.

Similar to a query scheme, a parsing scheme may be associated with a particular electronic message type or with a plurality of electronic message types. For some embodiments, a parsing scheme for a particular electronic message type is generated based on a set of sample electronic messages. An example process for generating a parsing scheme may be similar to one that generates a query scheme described herein. The example process may comprise first collecting sample electronic messages for a target organization. For a particular electronic message type, a set of sample electronic messages may be collected from each type of electronic message service to account for differences that may exist between different electronic message services.

Once collected, the example process for generating a parsing scheme may examine each sample electronic message for one or more of the following example characteristics of an electronic message: sender electronic message address; subject line; body content-type (e.g., text-only, or HTML); body content (e.g., distinguishing content strings in the body, such as specific words or specific HTML tags or HTML comments); and organization information (e.g., retailer contact information or physical address). Eventually, one or more of the characteristics (e.g., combination of any or all characteristics) examined in the sample electronic messages can be stored and used to determine which parsing scheme will be used with an electronic message (e.g., each electronic message) retrieved by operation 104. For instance, a mapping may be stored between an examined characteristic and a particular parsing scheme.

For some embodiments, a parsing scheme (e.g., parsing algorithm or engine) may be generated (e.g., manually or automatically) to extract specific data from a particular electronic message type (e.g., one identified by one or more characteristics, as described herein). A given parsing scheme may parse through an electronic message and extract specific data content of interest (e.g., with respect to the associated electronic message type). Further, a given parsing scheme may parse through an electronic message and determine when the electronic message is not relevant (e.g., to the associated electronic message type). Electronic messages determined to be irrelevant by a parsing scheme may be marked to be ignored, or set aside for further investigation (e.g., manual examination by a human individual).

Some embodiments comprise a set of master parsers, each of which may be associated with a target organization (e.g., retailer, artist, or service provider). A master parser may remove raw contents of each electronic message in the queue applicable to the master parser. The raw contents may include some or all header information, or some or all body information in an electronic message. Subsequently, a master parser may use one or more characteristics (described herein) of a particular electronic message to determine and select which parsing scheme will be used to parse the particular electronic message, or may determine that the particular electronic message should be ignored.

The parsing scheme selected by the master parser is used to parse contents of each non-ignored electronic message (e.g., parsed into an in-memory data structure). The selected parsing scheme may parse content of a non-ignored electronic message as follows. If the non-ignored electronic message contains HTML content (e.g., as determined by the content-type of the e-mail), the selected parsing scheme may traverse the HTML content to known locations in the Document Object Model (DOM) to extract individual pieces of content from the raw message content of the non-ignored electronic message.

If the non-ignored electronic message contains HTML content and is inconsistent between electronic messages or is complicated, the selected parsing scheme may convert the HTML content to non-HTML text content (e.g., using a standard HTML-to-Text software library) and content is then extracted as non-HTML text. If the non-ignored electronic message contains non-HTML text content, or HTML content of the non-ignored electronic message is converted to non-HTML text content (as described above), the non-HTML text content may be parsed by the selected parsing scheme as follows. First, if there are identifiable delimiters (e.g., predetermined words or symbols) in the non-HTML text content that can be used to segment the content into smaller chunks, the selected parsing scheme may separate the content into chunks accordingly to be subsequently processed independently. Second, for each identified chunk, or the entire non-ignored electronic message if there is no way of identifying pieces of the non-ignored electronic message, the selected parsing scheme can extract information from the non-ignored electronic message according to an ordered list of information, where the ordered list may be included by the selected parsing scheme. In addition to the ordered list of information to be extracted, the selected parsing scheme can also include a definition of when to advance to the next piece of information to be extracted. For each line to be processed, the selected parsing scheme may perform one of the following: a) identify the line as a piece of content to be extracted and extract it accordingly; b) identify the line as an indicator that the selected parsing scheme should transition to the next piece of content to be extracted and transition to the next piece accordingly; and c) ignore the line as unimportant.

For some embodiments, once all electronic messages have been parsed and their data extracted into an in-memory data structure, the extracted data may be placed into a processing queue for long-term storage for future use (e.g., by a customer analytics tool). In addition to the extracted data, additional data regarding the electronic messages may be placed into the processing queue for long-term storage. Examples of the additional data can include, without limitation, an electronic message identified (e.g., e-mail message identifier), a date or time at which the electronic message was sent or received, and an electronic message subject line (e.g., e-mail subject).

At times, a master parser (e.g., for a particular organization) may be unable to determine which parsing scheme to use to parse a given electronic message. In such an event, the given electronic message may be stored (e.g., in a database) and information regarding the given electronic message may also be stored (e.g., in a database) for future processing, such as machine learning classifier training or manual examination of the given electronic message. Example information that may be stored can include, without limitation, raw content of the given electronic message, an identifier for the electronic message service provider, and an identifier for the participant to whom the given electronic message belongs. During manual examination of the given electronic message, an individual (e.g., administrative user) may determine whether an existing parsing scheme can be modified to handle the type of electronic message represented by the given electronic message, or whether additional exclusions should be implemented (e.g., in a master parser) for the type of electronic message. After the given electronic message has been manually examined and a master parser or a parsing scheme adjusted accordingly, electronic messages stored for future processing may be again processed by the master parser, the parser scheme, or both, as described herein.

According to some embodiments, at least some of the data extracted from a participant's electronic messages during operation 106 is used to directly populate one or more attributes of the participant. These one or more attributes may be stored as part of a profile maintained for the participant. As described herein, a participant's profile may have been created when the participant initially registers with an embodiment at operation 102 (e.g., which may occur during registration to an online campaign).

Example attributes can include, without limitation: a participant gender; a participant age; a set of products that a participant has purchased; a set of retailers that a participant has shopped at; a set of brands that a participant has purchased; a participant's geography; a set of service providers a participant uses; a set of songs a participant has listened to; a set of albums a participant has listened to; a set of movies or television shows a participant has viewed; a set of likes (or comments) participant has submitted on a social media network; a campaign a participant has registered for; and a set of online subscriptions (e.g., newsletters or e-mail mailing lists) of a participant.

With respect to operation 108, participant data expansion, based on participant data extracted by the parsing of operation 106, may be utilized to determine a set of attributes (or attribute values thereof) of a participant, which may not have been directly determined (e.g., directly populated) from the data extracted from a participant's electronic messages during operation 106. The set of attributes determined may include one or more attributes in the participant's profile that remain unknown (e.g., missing an attribute value) after operation 106. The set of attributes determined may include information that is implicitly or explicitly determined from the information directly extracted from a participant's electronic messages during operation 106. The following discusses participant data expansion by an explicit data expansion class and by an implicit data expansion class.

For some embodiments, participant data expansion comprises using an explicit data expansion class that determines an attribute or attribute value by examining (e.g., looking for the presence of) a set of data signals in existing data associated with a participant, such as data extracted from a participant's electronic messages by operation 106 or other data from the participant's profile (e.g., data provided by the participant during registration with an embodiment). The set of data signals examples by a particular explicit data expansion class may strongly indicate (e.g., infer) a specific attribute of the participant, or a specific attribute value for the attribute (e.g., an attribute value in the participant's profile that remains unknown). In determining (e.g., inferring) an attribute or attribute value, an explicit data expansion class may examine a plurality of data signals and, while doing so, may apply a weighted score to each of those data signals to specify their importance in determining the attribute or attribute value.

For instance, a participant's gender may not have been provided by the participant during registration (e.g., during operation 102) or extracted from the participant's parsed electronic messages (e.g., during operation 106). In such an instance, some embodiments utilize a gender explicit data expansion class configured to examine a set of specific data signals in existing data (e.g., collected during participant registration or data extracted from the participant's electronic messages) to determine (e.g., infer) the participant's gender identity. A data signal examined by this gender explicit data expansion class may include, for example, salutations used in one or more electronic messages received by the participant (e.g., infer the participant is a male based on frequent use of “Mr.” in connection with the participant's name in the body of the participant's electronic messages). Other examples of data signals used by a gender explicit data expansion class can include, without limitation: a specific product purchase; a purchase from a specific vendor; a purchase of a specific brand; a gender ratio of a participant's social connections; gender pronouns used in electronic messaging; a count of electronic messages in inbox containing gender specific wording; subscriptions to newsletters, bulletin boards, online forums, or electronic message mailing lists associated with a particular gender.

For some embodiments, participant data expansion comprises using an implicit data expansion class that uses a machine learning model, such as a Bayesian classifier, to determine an attribute or attribute value. For some embodiments, the machine learning model of the implicit data expansion class may be trained on data from some or all participant profiles maintained by an embodiment and the trained machine learning model can output an inferred attribute or attribute value based on data inputs from existing data associated with a participant (e.g., data extracted from a participant's electronic messages by operation 106 or data provided by the participant during registration with an embodiment).

For instance, in the context of determining a participant's gender, an implicit data expansion class including a Bayesian classifier may be utilized to determine the participant's gender based on existing data associated with the participant. The Bayesian classifier may be trained on data from some or all participant profiles of an embodiment that have a gender attribute already defined/determined. In this way, the Bayesian classifier can be trained to identify, with reasonable probability, the gender of a participant (for whom the gender attribute may be unknown) based on data that is known about the participant (e.g., the participant's attributes that are known).

With respect to operation 110, generating participant analysis data based on at least one of the expanded participant data of operation 108 or extracted participant data of operation 106 may assist a client (e.g., one representing an organization) in understanding what attribute(s) or behavior(s) are common among the participants whose electronic messages were analyzed (e.g., by operations 102 through 108). Example features that convey this understanding to clients include, without limitations, participant cohorting and graphical dashboards.

According to some embodiments, participant cohorting comprises grouping (or collecting) participants into segments (hereafter, participant cohorts) based on their respective sets of attributes, which may be determined by either operation 106 or operation 108 as described herein. A participant cohort may be defined by a set of attribute filters, each of which may specify an attribute (e.g., by its attribute name) and specify a set of attribute values for the specified attribute. A given attribute filter, in the set of attribute filters, may be used to filter participants out of or filter participants into a participant segment. Some embodiments may include default participant cohorts that are available for client use, and may include participant cohorts that are automatically generated (e.g., based on data patterns detected using machine learning). Additionally, for some embodiments, a client selects one or more available attribute filters to build their own participant cohort. For instance, a client may choose to create a participant cohort based on the following attribute filters: have purchased Nike® products; are between the ages of 13 and 35; and are male.

According to various embodiments, a graphical dashboard is generated to visually present a set of metrics calculated for a participant cohort. In particular, the set of metrics may be calculated based on data (e.g., attributes) from the profile of each participant included within the participant cohort. Through the graphical dashboard, a client may explore demographic and behavioral characteristics of different participant cohorts, which may permit them to better understand existing or potential participants and may permit them to better target their marketing.

Example metrics presented through a graphical dashboard include, without limitation: total dollar volume of purchase orders; total count of purchase orders; total count of purchase orders; most popular retailers by order count; most popular retailers by dollar volume; top keywords in product names; top songs listened to; top albums listened to; daily breakdown of online campaign registration dates; count of registrations by service provider; geographical heat map; a participant gender breakdown; and a participant age breakdown.

With respect to operation 112, once a client has explored and understands the participant data analysis generated by operation 110, operation 112 permits a client to act on that knowledge. Based on participant analysis data generated by operation 110, operation 112 can generate a participant audience for syndication by a client. For instance, operation 112 may generate a participant audience based on a participant cohort generated by operation 110, or based on a metric calculated by operation 110 for the graphical dashboard. A client may generate the participant audience to syndicate, for example, marketing content (e.g., electronic messages comprising marketing content) to the participants included by the generated participant audience.

As used herein, a participant audience can comprise data that at least lists a set of electronic message addresses for participants identified as members of the participant audience. The participant audience data may further comprise participant names or one or more attributes from participant profiles (e.g., gender, age, etc.).

Through an embodiment, a client may generate a plurality of participant audiences in view of participant demographic and behavioral data. According to some embodiments, a client uses a generated participant audience with a third-party marketing service, such as Facebook® Ads or Google® Adsense®, by sharing the generated participant audience to the third-party marketing service. At the request of a client, an embodiment may share the generated participant audience with the third-party marketing service by first exporting the generated participant audience to a first account on the third-party marketing service associated with the embodiment (e.g., controlled by the embodiment). The exported participant audience may then be shared from the first account to a second account on the third-party marketing service associated with the client (e.g., controlled by the client). Once shared, the client may use the exported participant audience on the third-party marketing service through the second account. The exported participant audience may be temporarily shared from the first account to the second account (e.g., share expires after a certain period of time), and the exported participant audience may be shared as anonymized participant audience data (e.g., e-mail addresses are hashed using Secure Hash Algorithm 1 (SHA-1)). By anonymizing and temporarily sharing the exported participant audience, various embodiments can ensure that a client cannot copy and continue to use the exported participant audience after the temporary sharing ceases. This permits some embodiments to rent or lease use of the exported participant audience by a client on the third-party marketing service.

For some embodiments, the participant audience generated comprises a set of participants included by a particular participant cohort (e.g., one selected by the client based on the graphical dashboard). Additionally, for some embodiments, the participant audience generated comprises one or more participants that are like participants in a particular participant cohort, but that are not included by the particular participant cohort. This latter type of participant audience may be regarded as a “lookalike” participant audience.

For some embodiments, the participant audience generated by operation 112 may be utilized to determine or control access to an online interface (e.g., website access) relating to obtaining (e.g., purchasing or freely receiving) a product (e.g., merchandise), service (e.g., movie or concert tickets), benefit (e.g., discount or coupon on a purchase), or the like. A generated participant audience, for example, may be used as a participant access list that controls access for purchasing an item or service (e.g., concert tickets), may be used to determine a level of participant access, which can determine the types of items or services available for purchase through the participant access; or may be used to determine a priority of a participant's access (e.g., priority in the online queue) for purchasing an item or service.

FIG. 2 is a block diagram illustrating an example high-level client-server-based network architecture 200 including a customer analytics system 242 that implements an embodiment. The network architecture 200 includes a networked system 202 that provides server-side functionality via a communications network 204 (e.g., the Internet or wide area network (WAN)) to one or more client devices 210. In some implementations, a user (e.g., user 206) interacts with the networked system 202 using the client device 210. FIG. 2 illustrates, for example, a web client 212 (e.g., a browser) and applications executing on the client device 210 that may interface with the customer analytics system 242. The client device 210 includes the web client 212 and the applications 214 alone, together, or in any suitable combination. Although FIG. 2 shows one client device 210, in other implementations, the network architecture 200 comprises multiple client devices 210. According to some embodiments, the client device 210 permits a client or a participant to interact with the customer analytics system 242 as described herein.

In various implementations, the client device 210 comprises a computing device that includes at least a display and communication capabilities that provide access to the networked system 202 via the communications network 204. The client device 210 comprises, but is not limited to, a remote device, work station, computer, general purpose computer, Internet appliance, hand-held device, wireless device, portable device, wearable computer, cellular or mobile phone, personal digital assistant (PDA), smart phone, tablet, ultrabook, netbook, laptop, desktop, multi-processor system, microprocessor-based or programmable consumer electronic, game console, set-top box, network personal computer (PC), mini-computer, and so forth. In an embodiment, the client device 210 comprises one or more of a touch screen, accelerometer, gyroscope, biometric sensor, camera, microphone, Global Positioning System (GPS) device, and the like.

The client device 210 communicates with the communications network 204 via a wired or wireless connection. For example, one or more portions of the communications network 204 comprises an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some embodiments, the client device 210 includes one or more of the applications 214 (also referred to as “apps”) such as, but not limited to, web browsers, book reader apps (operable to read e-books), media apps (operable to present various media forms including audio and video), social media network apps, messaging apps, and electronic mail (email) apps. The web client 212 accesses the various systems of the networked system 202 via the web interface supported by a web server 222. Similarly, the client applications 214 access various services and functions provided by the networked system 202 via the programmatic interface provided by an application program interface (API) server 220.

Users (e.g., the user 206) comprise a person (e.g., client or participant), a machine, or other means of interacting with the client device 210. In some embodiments, the user is not part of the network architecture 200, but interacts with the network architecture 200 via the client device 210 or another means. For instance, the user provides input (e.g., touch screen input or alphanumeric input) to the client device 210 and the input is communicated to the networked system 202 via the communications network 204. In this instance, the networked system 202, in response to receiving the input from the user, communicates information to the client device 210 via the communications network 204 to be presented to the user. In this way, the user can interact with the networked system 202 using the client device 210.

The API server 220 and the web server 222 are coupled to, and provide programmatic and web interfaces respectively to, one or more application server 240. The application server 240 can host the customer analytics system 242, which can comprise one or more modules or applications and each of which can be embodied as hardware, software, firmware, or any combination thereof. The application server 240 is, in turn, shown to be coupled to a database server 224 that facilitates access to one or more information storage repositories, such as database 226. In an embodiment, the database 226 comprises one or more storage devices that store information to be accessed by customer analytics system 242 or the client device 210. Additionally, a third-party application 232, executing on third party server 230, is shown as having programmatic access to the networked system 202 via the programmatic interface provided by the API server 220. For example, the third-party application 232, utilizing information retrieved from the networked system 202, supports one or more features or functions on a website hosted by the third party. Depending on the embodiment, the third-party application 232 can represent an electronic message service supporting a participant's electronic message account, a credential authorization service, or a third-party marketing service.

Further, while the client-server-based network architecture 200 shown in FIG. 2 employs a client-server architecture, the present inventive subject matter is, of course, not limited to such an architecture, and can equally well find application in a distributed, or peer-to-peer, architecture system, for example. The various systems of the applications server 240 can also be implemented as standalone software programs.

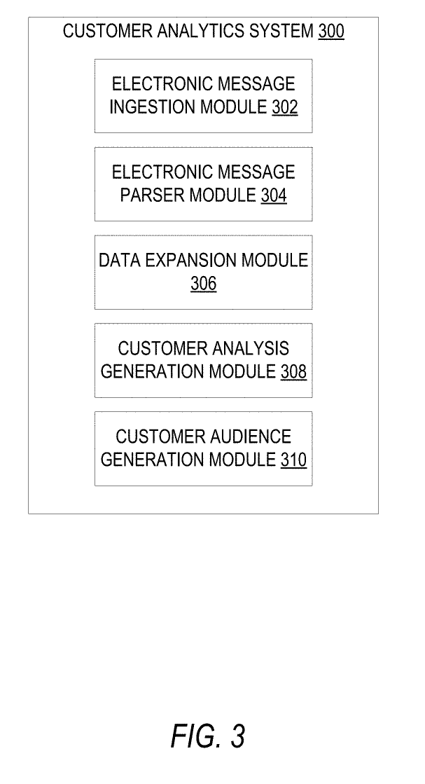

FIG. 3 is a diagram illustrating an example system 300 for customer analytics, according to some embodiments. As shown, the system 300 comprises an electronic message ingestion module 302, an electronic message parser module 304, a data expansion module 306, a participant analysis generation module 308, and a participant audience generation module 310. For various embodiments, the components and arrangement of components may vary from what is illustrated in FIG. 3. According to some embodiments, the modules 302 through 310 operate in accordance with the method 100 described above with respect to FIG. 1.

During operation, the electronic message ingestion module 302 may first obtain access (e.g., authorization for access) to a participant's electronic message account. Through the obtained access, the electronic message ingestion module 302 may retrieve (e.g., ingest) from the participant's electronic message account, a set of participant electronic messages identified within the participant electronic message account based on a set of query schemes, as described herein. The electronic messages retrieved by the electronic message ingestion module 302 may be placed on a queue (e.g., implemented by the database 226) for further processing. The electronic message parser module 304 may obtain electronic messages from the queue and parse the raw content of each to extract participant data according to a parsing scheme, as described herein. The electronic message parser module 304 may then directly populate one or more attributes relating to the participant from the extracted participant data. The data expansion module 306, in turn, may expand on data relating to the participant (e.g., populate attributes not determined by the electronic message parser module 304) based on explicit or implicit data expansion in view of the extracted participant data or known participant attributes, as described herein. The participant analysis generation module 308 can generate participant analysis data based on at least one of the expanded participant data from the data expansion module 306 or extracted participant data from the electronic message parser module 304. The generated participant analysis may include generation of a participant cohort and generation of a graphical dashboard to present a calculated metric in connection with a participant cohort. The participant audience generation module 310 can generate a participant audiences for syndication based on participant analysis (e.g., set of participant cohorts) generated by the participant analysis generation module 308.

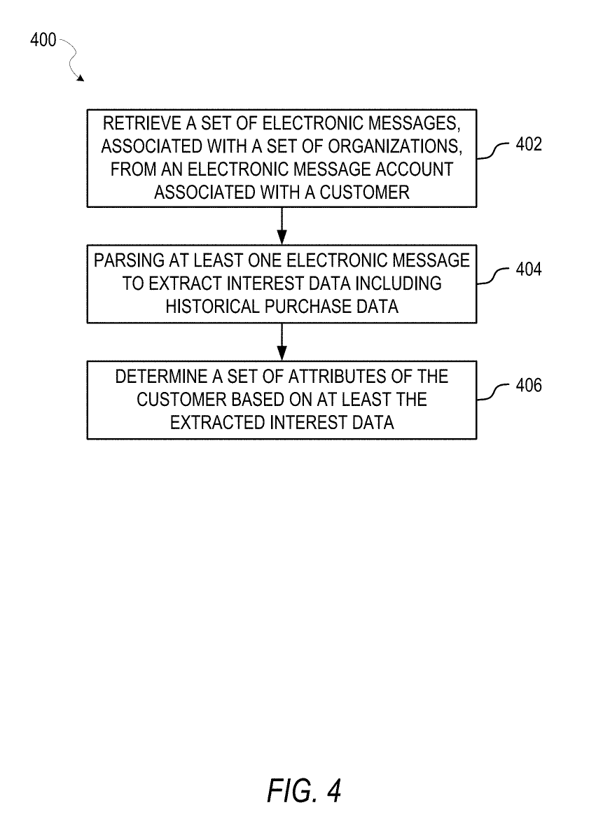

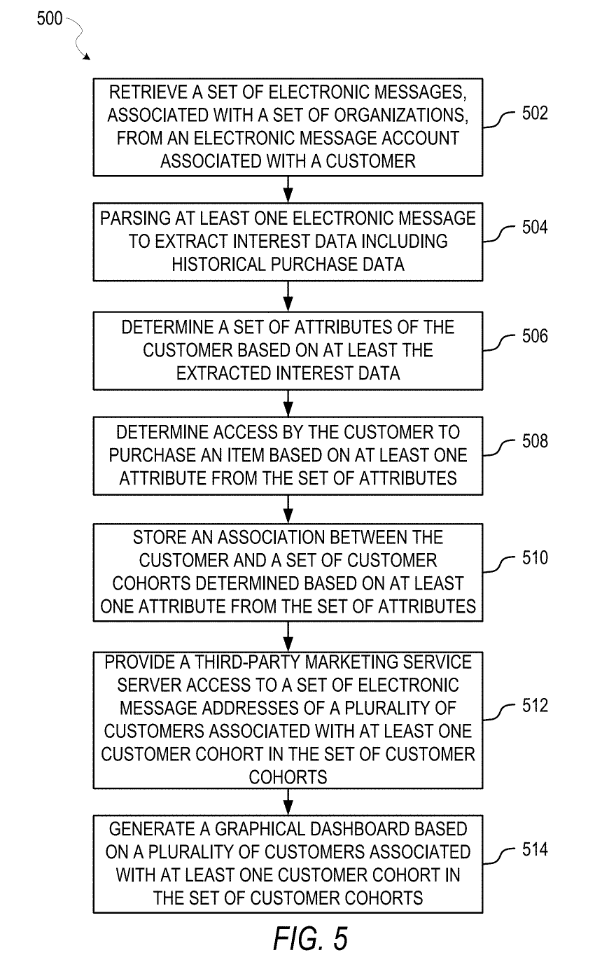

FIGS. 4 and 5 are flowcharts illustrating example methods for customer analytics, according to some embodiments. It will be understood that example methods described herein may be performed by a device, such as a computing device executing instructions of a customer analytics system, in accordance with some embodiments. Additionally, example methods described herein may be implemented in the form of executable instructions stored on a computer-readable medium or in the form of electronic circuitry. For instance, the operations of a method 400 of FIG. 4 may be represented by executable instructions that, when executed by a processor of a computing device, cause the computing device to perform the method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to FIG. 4, the flowchart illustrates an example method 400 for customer analytics, according to some embodiments. An operation of the method 400 (or another method described herein) may be performed by a hardware processor (e.g., central processing unit or graphics processing unit) of a computing device (e.g., desktop, server, etc.).

The method 400 as illustrated begins with operation 402 retrieving a set of electronic messages, associated with a set of organizations, from an electronic message account associated with a participant. As noted herein, the organization may include retailers, services providers, marketers, brand strategists, and the like. For instance, retrieving the set of electronic messages associated with the set of organizations may comprise: obtaining, based on authorization by the participant, an access credential (e.g., via OAuth) from a third-party service provider server that provides the electronic message account and establishing access to the electronic message account based on the access credential. The set of electronic messages may then be retrieved, by the established access, from the electronic message account. Additionally, the set of electronic messages may be retrieved based on a set of query templates corresponding to the set of organizations. A particular query template for a particular organization may be generated by first collecting a set of sample electronic messages associated with the particular organization. Then, for each sample electronic message in the set of sample electronic messages, a set of electronic message characteristics, including a sender electronic message address (and may further include a subject line of the sample electronic message), may be determined; and the particular query template may be generated based on the set of electronic message characteristics.

A query template may be similar to a query scheme described herein. Additionally, aspects of operation 402 may be similar to operations 102 and 104 of the method 100 described above with respect to FIG. 1.

The method 400 continues with operation 404 parsing at least one electronic message from the set of electronic messages retrieved by operation 402, to extract interest data including historical purchase data. Additionally, interest data may further include data indicating a subscription to receive an electronic message from a particular electronic message sender (e.g., sender e-mail address associated with a mailing list). The interest data may comprise any data within an electronic message that can indicate a participant's interest levels (e.g., in products, services, events, artists, celebrities, media, etc.). For instance, past purchases may be a stronger indicator of a participant's interest. A participant's subscription (e.g., opt-in) to an e-mail newsletter or mailing list may be another strong indicator of a participant's interest.

Parsing an electronic message to extract the historical purchase data may comprise parsing transactional data included by the at least one electronic message, the transactional data including a purchase item identifier. The transactional data may include at least one of a service name, a service description, a product name or other product identifier (e.g., stock keeping unit (SKU) identifier or a universal product code (UPC)), or a product description. The product or service description may include, for instance, dates or times associated with the product or service (e.g., date and time associated with a movie ticket).

Parsing an electronic message to extract the historical purchase data may also comprise determining a set of electronic message characteristics that at least includes a sender electronic message address. Based on the set of electronic message characteristics, a particular parser may be identified in a set of parsers associated with at least one organization in the set of organizations. The electronic message may then be parsed by the identified particular parser.

A particular parser may be generated by first collecting a set of sample electronic messages associated with the particular organization. Then, for each sample electronic message in the set of sample electronic messages, a set of electronic message characteristics, including a sender electronic message address, can be determined. The particular parser may then be generated based on the set of electronic message characteristics.

During parsing, the content of an electronic message may be determined to include markup language (e.g., HTML or XML). In response to this determination, a parser may extract a set of information from the electronic message content based on a Document Object Model (DOM). As described herein, the set of information extracted may include information relating to a purchase associated with the participant.

Additionally, parsing an electronic message may result in parsed message data being produced. From the parsed message data, a set of information may be extracted based on a predefined approach that specifies an order in which pieces of information are to be extracted. The predefined approach may also specify a set of rules for determining whether to advance to a next piece of information in the order.

Aspects of operation 404 may be similar to operation 106 of the method 100 described above with respect to FIG. 1.

The method 400 continues with operation 406 determining a set of attributes of the participant based on at least the interested data extracted by operation 404. An attribute of the participant may relate to a demographic of the participant, an interest of the participant, or a behavior of the participant. Determining the set of attributes of the participant may be further based on the set of data signals identified within the parsed message data produced by operation 404. Determining the set of attributes of the participant may be further based on a machine learning model (e.g., Bayesian classifier) applied to a set of known attributes of the participant. The machine learning model may be trained on a set of profiles of other participants having a plurality of known attributes.

Additionally, determining the set of attributes of the participant may be further based on a set of social media signals obtained from a social media account associated with the participant. For instance, with access to a participant's social media profile, an embodiment may obtain the social media signals relating to the participant, such as the participant's likes, comments, interests, and the like. Using these obtained social media signals, an embodiment may determine one or more attributes of the participant, which may involve explicit or implicit data expansion as described herein with respect to electronic messages.

Aspects of operation 406 may be similar to operations 106 and 108 of the method 100 described above with respect to FIG. 1.

Referring now to FIG. 5, the flowchart illustrates an example method 500 for customer analytics, according to some embodiments. An operation of the method 500 may be performed by a hardware processor of a computing device. The method 500 as illustrated begins with operation 502 and continues with operations 504 and 506, which are similar to operations 402, 404, and 406 respectively according to some embodiments.

The method 500 continues with operation 508 determining access (e.g., website access) by the participant to purchase an item or a service based on at least one attribute from the set of attributes determined by operation 506. The item may be one that is in high demand by consumers (e.g., ticket to a concert) and, as such, the seller (e.g., musical artist) may want to limit or prioritize access to purchasing the item to certain participants. For instance, through an embodiment, a musical artist can grant or prioritize access to purchasing concert tickets to those participants that based on analysis of their electronic messages (e.g., by operations 502 through 506), appear to be loyal or longtime fans of the musical artist. The access determined by operation 508 may control whether a participant can access an interface (e.g., online interface) for purchasing the item and, further, may control the order in which the participant can access the interface relative to other participants.

The method 500 continues with operation 510 storing an association between the participant and a set of participant cohorts determined based on at least one attribute from the set of attributes determined by operation 506. Aspects of operation 510 may be similar to operation 110 of the method 100 described above with respect to FIG. 1.

The method 500 continues with operation 512 providing a third-party marketing services server access to a set of electronic message addresses of a plurality of participants associated with at least one participant cohort in the set of participant cohorts. Aspects of operation 512 may be similar to operation 112 of the method 100 described above with respect to FIG. 1.

The method 500 continues with operation 514 generating a graphical dashboard based on a plurality of participants associated with at least one participant cohort in the set of participant cohorts. The generated graphical dashboard can include one or more metrics (e.g., percentages or statistics) calculated in connection with a participant cohort. Additionally, the graphical dashboard can break down the metrics according to one or more attributes present or absent in a participant cohort. Aspects of operation 514 may be similar to operation 110 of the method 100 described above with respect to FIG. 1.

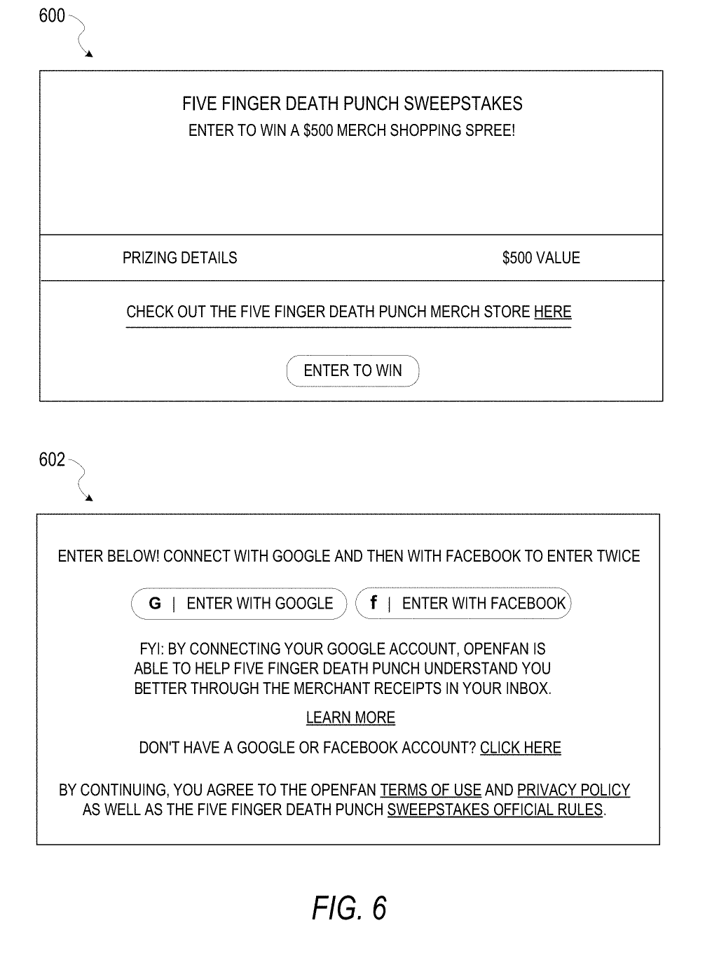

FIG. 6 is a set of screenshots 600 and 602 illustrating example interfaces for an online campaign that facilitates user access authorization, according to some embodiments. In particular, screenshot 600 illustrates a website providing details regarding the online campaign (to win a prize valued at $500) and a webpage button that a participant may select to enter to win the prize. Screenshot 602 illustrates a webpage interface that may appear upon the participant's request to enter to win the prize. Through the webpage interface, a participant can choose to enter using either their Google® account, Facebook® account, or both. By selecting to enter using one or both accounts, the participant will start the process by which the participant registers with an embodiment and authorizes the embodiment to analyze their electronic messages (e.g., in electronic message inboxes associated with the selected account(s)) as described herein.

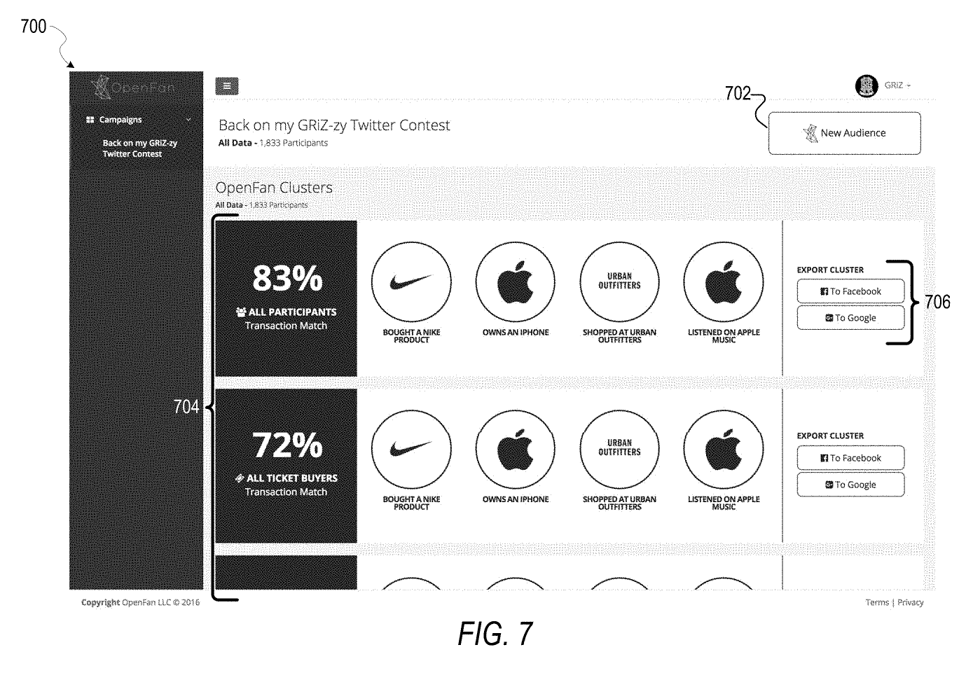

FIG. 7 is a screenshot 700 illustrating an example graphical dashboard for customer analytics, according to some embodiments. As shown, the example graphical dashboard presents customer analytics for participants (e.g., existing or potential customers) that either registered in association with a particular client or registered through the efforts of multiple clients. For instance, the participants may be existing or potential participants that registered through an online campaign (e.g., sweepstake) sponsored by a particular client and, as such, the participants analyzed may be exclusively associated with the particular client. Alternatively, a given client may be granted access to customer analytics for some or all participants registered by efforts of other clients. This access may be granted upon permission of those other clients and may involve an additional fee to the operator of the embodiment.

In screenshot 700, the graphical dashboard relates to participants registered under an online campaign entitled “GRIZ-zy Twitter Contest” and indicates that one thousand eight hundred and thirty-three participants participated in the online campaign. As described herein, an embodiment analyzes the electronic messages of those participants and, eventually, generates participant cohorts that group the participating participants (e.g., into “clusters”). Section 704 presents a metric (82%) calculated by an embodiment for a participant cohort that includes all the participant participants and another metric (72%) calculated by the embodiment for a participant cohort that includes only ticket buyers. Graphical button 702 permits the client to generate an additional participant cohort (e.g., based on selected attribute filters as described herein), which can then be presented in section 704 in connection with a metric.

As shown, section 704 presents various participant cohorts in connection with a calculated metric (e.g., 83% and 72%) and attributes relating to the participant cohorts. In particular, section 704 indicates that for a participant cohort including all the participants that participated in the online campaign, 83% of the participant cohort bought a Nike® product, own an iPhone®, shopped at Urban Outfitter®, and listened to Apple® Music. Section 704 also indicates that for a participant cohort including only ticket buyers, 72% of those ticket buyers bought a Nike® product, own an iPhone®, shopped at Urban Outfitter®, and listened to Apple® Music. A client can modify these participant cohorts to include or exclude available attributes (e.g., through attribute filters) as they wish.

As also shown, through graphical buttons 706, a client is provided with an option to export, to a third-party service (e.g., Google® or Facebook®), a participant audience in connection with a participant cohort presented in section 704. As described herein, a client may choose to export a participant audience directly using participants included by the selected participant cohort or may choose to export a “lookalike” participant audience that is based on the selected participant cohort. As also described herein, the third-party service receiving the audience data may be a marketing service, where the client can use the exported participant audience for specific marketing purposes (e.g., a targeted e-mail marketing campaign). As noted herein, an embodiment may share the generated participant audience with the third-party marketing service by first exporting the generated participant audience to a first account on the third-party marketing service associated with the embodiment (e.g., controlled by the embodiment), and the exported participant audience may then be shared from the first account to a second account on the third-party marketing service associated with the client (e.g., controlled by the client). Once shared, the client may use the exported participant audience on the third-party marketing service through the second account. The exported participant audience may be temporarily shared from the first account to the second account (e.g., share expires after a certain period of time), and the exported participant audience may be shared as anonymized participant audience data (e.g., e-mail addresses are hashed using Secure Hash Algorithm 1 (SHA-1)). By anonymizing and temporarily sharing the exported participant audience, various embodiments can ensure that a client cannot copy and continue to use the exported participant audience after the temporary sharing ceases. This permits some embodiments to rent or lease use of the exported participant audience by a client on the third-party marketing service.

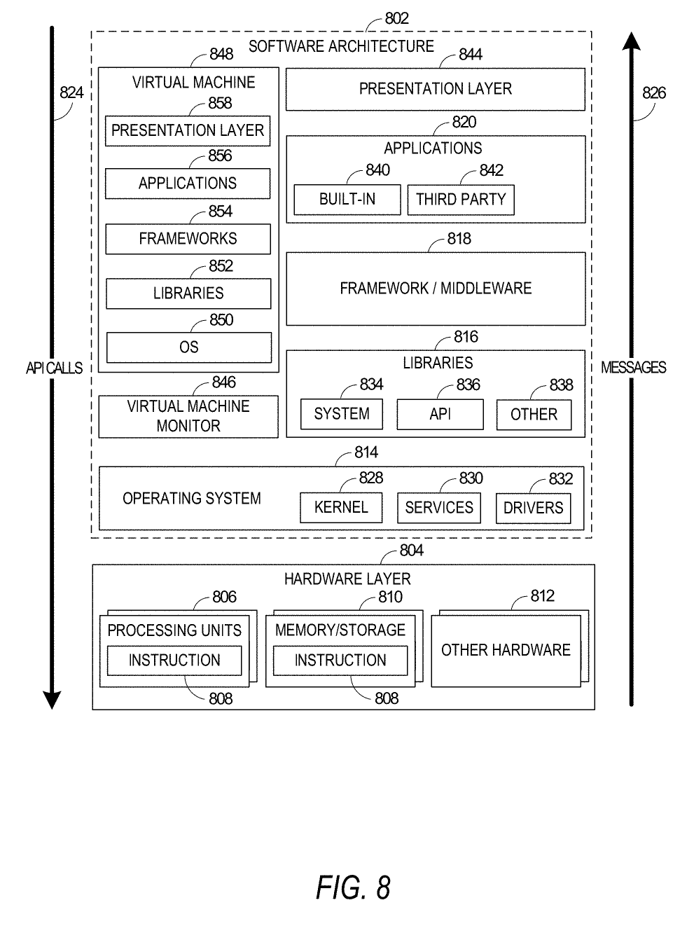

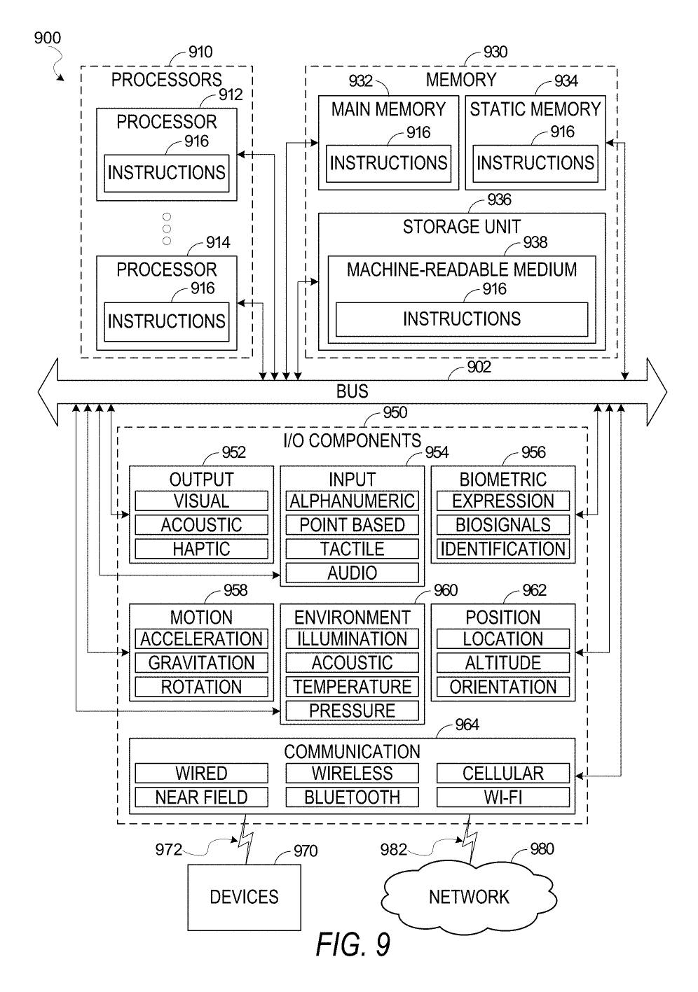

Various embodiments described herein may be implemented by way of the example software architecture illustrated by and described with respect to FIG. 8 or by way of the example machine illustrated by and described with respect to FIG. 9.

FIG. 8 is a block diagram illustrating an example of a software architecture that may be installed on a machine, according to some example embodiments. FIG. 8 is merely a non-limiting example of a software architecture, and it will be appreciated that many other architectures may be implemented to facilitate the functionality described herein. The software architecture 802 may be executing on hardware such as a machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802, including implementation of the methods, modules, and so forth of FIGs. X-X. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system 834, APIs 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. A virtual machine 848 creates a software environment where applications/modules can execute as if they were executing on a hardware machine e.g., the machine 900 of FIG. 9, for example). A virtual machine 848 is hosted by a host operating system (e.g., operating system 814) and typically, although not always, has a virtual machine monitor 846, which manages the operation of the virtual machine 848 as well as the interface with the host operating system (e.g., operating system 814). A software architecture executes within the virtual machine 848, such as an operating system 850, libraries 852, frameworks/middleware 854, applications 856, or a presentation layer 858. These layers of software architecture executing within the virtual machine 848 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to an embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute the method 100 of FIG. 1, the method 400 of FIG. 4, or the method 500 of FIG. 5. Additionally, or alternatively, the instructions 916 may implement FIG. 3. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an embodiment, the processors 910 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, both accessible to the processors 910 such as via the bus 902. The main memory 932, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions 916 and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
retrieving, by a hardware processor, a set of electronic messages from an electronic message account, the set of electronic messages being associated with a set of organizations and the electronic message account being associated with a participant;
parsing, by the hardware processor, at least one electronic message from the set of electronic messages to extract interest data of the participant from the at least one electronic message, the interest data including historical purchase data; and
determining, by the hardware processor, a set of attributes of the participant based on at least the interest data, the set of attributes including an attribute relating to an interest of the participant.

2. The method of claim 1, wherein the interest data further includes data indicating a subscription to receive an electronic message from a particular electronic message sender.

3. The method of claim 1, wherein the parsing the at least one electronic message to extract the historical purchase data comprises parsing transactional data included by the at least one electronic message, the transactional data including a purchase item identifier.

4. The method of claim 3, wherein the transactional data includes at least one of a service name, a service description, a product name, or a product description.

5. The method of claim 1, wherein the retrieving the set of electronic messages associated with the set of organizations comprises:
obtaining, based on authorization by the participant, an access credential from a third-party service provider server that provides the electronic message account;
establishing access to the electronic message account based on the access credential; and
retrieving, by the established access, the set of electronic messages from the electronic message account.

6. The method of claim 1, wherein the retrieving the set of electronic messages associated with the set of organizations comprises:
retrieving, from the electronic message account, the set of electronic messages associated with the set of organizations based on a set of query templates corresponding to the set of organizations.

7. The method of claim 6, wherein a particular query template, in the set of query templates corresponding to the set of organizations, is generated for a particular organization, in the set of organizations, by:
collecting a set of sample electronic messages associated with the particular organization;
for each sample electronic message in the set of sample electronic messages, determining a set of electronic message characteristics that at least includes a sender electronic message address; and
generating the particular query template based on the set of electronic message characteristics.

8. The method of claim 1, wherein the parsing the at least one electronic message to extract the historical purchase data of the participant from the at least one electronic message comprises:
determining a set of electronic message characteristics that at least includes a sender electronic message address;
identifying a particular parser, in a set of parsers associated with at least one organization in the set of organizations, based on the set of electronic message characteristics; and
parsing the at least one electronic message by the particular parser.

9. The method of claim 8, wherein a particular parser, in the set of parsers associated with at least one organization in the set of organizations, is generated by:
collecting a set of sample electronic messages associated with the particular organization;
for each sample electronic message in the set of sample electronic messages, determining a set of electronic message characteristics that at least includes a sender electronic message address; and
generating the particular parser based on the set of electronic message characteristics.

10. The method of claim 1, wherein the parsing the at least one electronic message to extract the historical purchase data of the participant from the at least one electronic message comprises:
responsive to content of the at least one electronic message including a markup language, extracting a set of information from the content based on a Document Object Model (DOM), the set of information including at least information relating to a purchase associated with the participant.

11. The method of claim 1, wherein the parsing the at least one electronic message to extract the historical purchase data of the participant from the at least one electronic message comprises:
producing parsed message data from the at least one electronic message; and
extracting, from the parsed message data, a set of information based on a predefined approach that at least specifies an order in which pieces of information are to be extracted and specifies a rule for determining whether to advance to a next piece of information in the order, the set of information including at least information relating to a purchase associated with the participant.

12. The method of claim 1, wherein the parsing the at least one electronic message produces parsed message data, and the determining the set of attributes of the participant is further based on the set of data signals identified within the parsed message data.

13. The method of claim 1, wherein the parsing the at least one electronic message produces parsed message data, and the determining the set of attributes of the participant is further based on a Bayesian classifier applied to a set of known attributes of the participant, the Bayesian classifier being trained on a set of profiles of other participants having a plurality of known attributes.

14. The method of claim 1, wherein the determining the set of attributes of the participant is further based on a set of social media signals obtained from a social media account associated with the participant.

15. The method of claim 1, further comprising determining access by the participant to purchase an item or a service based on at least the attribute relating to an interest of the participant.

16. The method of claim 15, wherein the attribute relating to the interest of the participant comprises an interest level associated with the interest, and the determining access by the participant to purchase the item comprises:
providing access to the participant to purchase the item responsive to the interest level meeting or exceeding a threshold interest level.

17. The method of claim 1, further comprising storing an association between the participant and a set of participant cohorts determined based on the attribute relating to an interest of the participant.

18. The method of claim 17, further comprising providing, a third-party marketing service server, access to a set of electronic message addresses of a plurality of participants associated with at least one participant cohort in the set of participant cohorts.

19. The method of claim 17, further comprising generating a graphical dashboard based on a plurality of participants associated with at least one participant cohort in the set of participant cohorts, the graphical dashboard including a set of metrics regarding the at least one participant cohort.

20. A system comprising:
a memory storing instructions; and
a hardware processor communicatively coupled to the memory and configured by the instructions to:
retrieve, from an electronic message account, a set of electronic messages associated with a set of organizations, the electronic message account being associated with a participant;
parse at least one electronic message, from the set of electronic messages, to extract interest data of the participant from the at least one electronic message, the interest data including historical purchase data; and
determine a set of attributes of the participant based on at least the interest data, the set of attributes including an attribute relating to an interest of the participant.

21. A non-transitory computer storage medium comprising instructions that, when executed by a hardware processor of a device, cause the device to perform operations comprising:
retrieving, from an electronic message account, a set of electronic messages associated with a set of organizations, the electronic message account being associated with a participant;
parsing at least one electronic message, from the set of electronic messages, to extract interest data of the participant from the at least one electronic message, the interest data including historical purchase data; and
determining a set of attributes of the participant based on at least the interest data, the set of attributes including an attribute relating to an interest of the participant.
